(19) United States
(12) Patent Application Publication
(10) Pub. No.: US 2008/0114856 A1
(43) Pub. Date: May 15, 2008

(54) System and method for autonomously delivering information on demand

(76) Inventor: Gary Kendall, Norcross, GA (US)

Correspondence Address: MCKENNA LONG & ALDRIGE LLP;Song K. Jung, 1900 K Street, N.W., Washington, DC, 20006, US

(21) Appl. No.: 11/594,951

(22) Filed: Nov. 9, 2006

(51) Int. Cl. G06F 15/16; G06Q 30/00

(52) U.S. Cl. 709/217; 705/36 R

(57) ABSTRACT

Disclosed is a system for delivering information, such as a portfolio, on demand and over a wireless network. The system comprises an autonomous portfolio delivery device and a mobile device. The portfolio delivery device has a memory device encoded with portfolio information and embedded software for transmitting the portfolio to the mobile device in response to a request from the mobile device. The mobile device, which may be a laptop or PDA, has special-purpose software for identifying the delivery device when in wireless range. The system enables, for example, a home seller to provide, on demand and in real time, extensive information about the home to a potential buyer. The system enables a potential home buyer to obtain immediate information about the home, such as a photo tour and information regarding schools, community, shopping, etc., while in the vicinity of the property.

### BACKGROUND OF THE INVENTION

1. Field of the Invention

The present invention generally relates to systems for providing information over a wireless connection. More particularly, the present invention relates to systems for delivering information about real property to a user of a mobile electronic device in the vicinity of the site where the real property is located.

2. Discussion of the Related Art

In market sectors such as consumer and commercial real estate, competition is very intense. The ability to quickly and conveniently deliver information to potential buyers is crucial for a firm to gain and maintain market share. Throughout the business world, successful companies have gained market leverage by developing new forms of delivery of information, whether the information is in the form of content (e.g., satellite radio, “podcasting” news, internet-based auctions, etc.) or in the form of advertising.

The discussion below pertains to the real property market. However, one of ordinary skill will readily recognize that the issues discussed may apply to any field where a provider of products and/or services must provide information efficiently and effectively.

In a consumer real estate context, a house for sale typically has a “for sale” sign placed in the front yard and a box containing flyers that provide information about the house. The “for sale” sign typically has a phone number and a website designation. The flyers typically contain one page of information each. The information on the flyer is generally limited and not very informative. The box contains a limited number of flyers and is usually emptied quickly. As such, a potential buyer approaching the house has access to limited information at best, and no information in may cases. This can result in lost opportunities for property sellers, real estate agents and brokers. Limited information at the property site may influence a candidate buyer to move on without further consideration.

Real estate web sites often provide information about homes for sale, including photo tours of the house. However, this information is generally inaccessible to a potential buyer while in the vicinity of the house and can be difficult to access. As such, a potential buyer must get information about the house, e.g., from the “for sale” sign, and later use this information to search the realtor's website for information about the house.

Accordingly, a potential home buyer has limited opportunities to gain immediate information about a house for sale, resulting in a gap in promotional opportunities for a home seller. One will readily recognize that similar situations may arise regarding other real property, such as rental and commercial properties, new residential construction, condominiums, and the like.

To bridge this information gap what is needed is a system for delivering a broad range of information about real property to interested parties at the asset location, in real time. Further, what is needed is portfolio data available at the real property site that provides sufficient information to assist the potential buyer or interested party in an immediate real time evaluation of the property, as well as assist agents and brokers in evaluating competing properties.

### SUMMARY OF THE INVENTION

The present invention provides a system and method for autonomously delivering information on demand that obviates one or more of the aforementioned problems due to the limitations of the related art.

Accordingly, one advantage of the present invention is that it improves a seller's ability to provide timely information to a potential buyer while the potential buyer is in the vicinity of the asset.

Another advantage of the present invention is that it improves a potential buyer's ability to anonymously obtain information about real property.

Still another advantage of the present invention is that it improves a seller's ability to quickly update information about real property in a secure and timely manner.

Additional advantages of the invention will be set forth in the description that follows, and in part will be apparent from the description, or may be learned by practice of the invention. The advantages of the invention will be realized and attained by the structure pointed out in the written description and claims hereof as well as the appended drawings

To achieve these and other advantages, the present invention involves a system for transmitting, on demand, a portfolio of information pertaining to real property. The system comprises a portfolio delivery device having a first wireless communication component, an embedded controller, and a first computer readable medium, wherein the first computer readable medium is encoded with data corresponding to the portfolio and a first program, wherein the first program transmits all or part of the portfolio on demand; and a mobile device having a second wireless communication component, a processor, and a second computer readable medium encoded with a second program, wherein the second program identifies a wireless transmission from the portfolio delivery device, establishes a wireless link with the portfolio delivery device, requests the portfolio from the portfolio delivery device, and receives data corresponding to the portfolio from the portfolio delivery device.

In another aspect of the present invention, the aforementioned and other advantages are achieved by a computer readable medium encoded with a program for creating a portfolio for promotional sale of real property products. The program comprises a software component for requesting and receiving product information from a seller; a software component for querying one or more databases for additional product information based on the product information received from the seller; a software component for assembling portfolio based on the product information and the additional product information, according to a template; and a software component for generating a program for transmitting the portfolio in response to a request.

In another aspect of the present invention, the aforementioned and other advantages are achieved by a method for transmitting a portfolio on demand. The method comprises obtaining a program that generates the portfolio; executing the program; providing information corresponding to a real property in response to a prompt from the program; commanding the program to generate the portfolio and to generate an embedded program that transmits the portfolio to a mobile device over a wireless connection in response to a request from the mobile device; commanding the program to load the program into a memory device, wherein the memory device is connectable to a delivery device; and placing the delivery device, which is connected to the memory device, in or near the product.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

FIG. 1 illustrates an exemplary system for autonomously delivering a portfolio on demand according to the present invention;

FIG. 2 illustrates the system of FIG. 1, including further system components for configuring the devices within the system; and

FIG. 3 illustrates an exemplary process for configuring and operating the systems illustrated in FIGS. 2 and 3.

### DETAILED DESCRIPTION OF THE ILLUSTRATED EMBODIMENTS

The present invention involves the use of an information delivery system whereby a seller, such as a realtor, places an information delivery device in or near (such as in the window or on a “for sale” sign) a property (e.g., a house) that is for sale. A potential buyer, equipped with a wireless device, enters the vicinity of the property and establishes a wireless communication link with the information delivery device. Once the link is established, the potential buyer may download a portfolio of information pertaining to the property. Assuming, for a moment, that the property involves a house, the portfolio may include information of interest to the potential buyer, such as photos of the interior of the house, a video tour of the house, information about the school system, distance to emergency services, distance to public transportation, shopping, and the like. The potential buyer may choose to view or browse the portfolio, download part or all of the portfolio, bookmark the link for later web access, as well as transmit information to the delivery system for the purpose of leaving information with the seller. The portfolio may be downloaded to the potential buyer's wireless device while the potential buyer is in the vicinity of the house, such as in a car. In this manner, a potential buyer may immediately obtain a wealth of information about a house in real time, and may conveniently do so for multiple houses in a relatively short amount of time.

Although the description below relates to a consumer real estate implementation, it will be readily apparent to one skilled in the art that the description below may pertain to other applications that benefit from timely location based information delivery, such as any sale of property by owner or a realtor, apartments, condominiums, land use information, commercial property, and the like. All such applications, and many others, are possible and within the scope of the invention. As used herein, the term “portfolio” may refer to information, such as promotional information, pertaining to any of the applications listed above.

As used herein, the term “seller” may refer to the owner of the house or real property, a real estate agent, a licensed portfolio developer, a real estate developer, a home builder, or a computer consultant working for any of the above. The term “potential buyer” may refer to a consumer, a realtor or agent representing a buyer, any interested party, etc. The term “product” may refer to any real property.

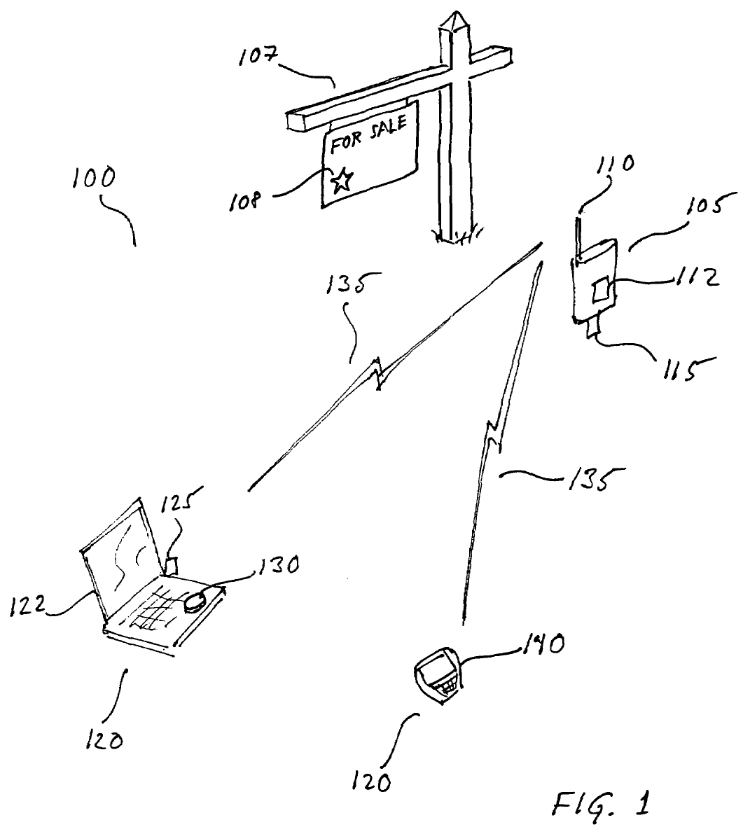

FIG. 1 illustrates an exemplary system 100 for delivering a portfolio to a mobile device according to the present invention. System 100 includes a delivery device 105 and a mobile device 120. Mobile device 120 can be a laptop 122, a personal digital assistant (PDA) 140, or a similar wireless electronic device having a memory and a processor. As illustrated in FIG. 1, delivery device 105 and mobile devices 120 communicate via a wireless link 135. System 100 may also include a sign 107, such as a “for sale” sign, which has a visual indicator or marker 108. Visual indicator 108 tells passers-by that the site is supported by portfolio delivery system 100, and that a delivery device 105 is present.

The wireless link 135 may be implemented according to a wireless LAN/WAN scheme, such as WiFi (IEEE 802.11). However, the present invention is not limited to this wireless scheme, and others may be used. Wireless link 135 may have a limited range, such as 30-100 meters, to reduce the number of wireless channels that mobile device 120 may encounter from other wireless links with other nearby delivery devices.

Delivery device 105 contains portfolio information. Delivery device 105 may include an embedded controller 112, a communication component 110, and a memory device 115. Communication component 110 is a device for communicating according to the standard used for wireless link 135. Communication component 110 may include an internal printed circuit board (PCB) antenna and/or an external dipole or monopole antenna, although other antenna configurations may be used, provided that it supports the wireless scheme of wireless link 135. Embedded controller 112 controls communication component 110 and coordinates the transfer of data to/from memory device 115. Embedded controller 112 may be an embedded microprocessor or microcontroller. Embedded controller 112 may include an IDE controller for controlling memory device 115, although other memory drive controllers may be used, depending on memory device 115.

Memory device 115 may be a removable memory drive, such as a USB memory stick, or may be an internal memory drive, such as a hard drive integrated within delivery device 105. Other types of memory, such as integrated non-volatile flash memory, may be used. Memory device 115 has sufficient capacity to store data corresponding to one or more portfolios as well as information such as the number of times a given portfolio has been delivered to a wireless device 120, and possibly the date and time of each delivery. Depending on the number and/or size of the portfolio(s), the capacity of memory device may be from a few MB to many GB.

Delivery device 105 may be a custom designed device specific to this function, or may include a commercial off-the-shelf (COTS) device.

Delivery device 105 may be customized for particular uses. For example, delivery device 105 may be designed with the objective of minimal cost. In this case, memory device 115 may be a memory stick, which contains a portfolio and any control software for embedded controller 112.

Delivery device 105 may or may not be connected to the internet. In the latter case, not being connected to the internet may provide the benefit of security in that there is no way that anyone could improperly use delivery device 105 to gain access to the internet. In this case, the lack of connectivity to the internet is a security feature.

In cases where delivery device 105 is to be deployed in remote locations, it may be desired to design delivery device 105 such that its power consumption is minimized. Delivery device 105 may include a battery or a solar cell for powering itself in remote locations or locations where power sources are not available. Additionally, delivery device 105 may include a secure weather-proof housing that may enable it to be mounted to a “for sale” sign or otherwise be deployed outdoors. It will be readily apparent to one of ordinary skill that such variations of delivery device 105 are possible and within the scope of the invention.

As mentioned above, mobile device 120 may be a laptop 122, a PDA 140, or a similar wireless device having a processor and a memory. The description below of mobile device 120 will use laptop 122 as an example, although it applies equally well to PDA 140, given variations that will be apparent to one skilled in the art. Laptop 122 includes a mobile wireless communication device 125, and a memory 130. Memory 130 contains instructions and data for establishing wireless link 135 with, interacting with, and receiving a portfolio from delivery device 105 (hereinafter “mobile device software”).

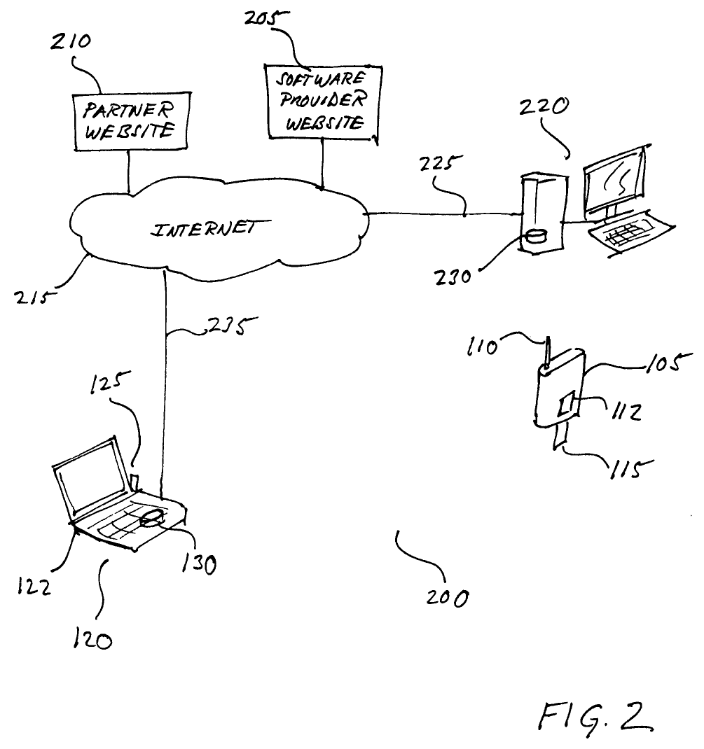

FIG. 2 illustrates exemplary system 200 for configuring and operating the components of exemplary system 100 described above. System 200 includes delivery device 105 and mobile device 120 (illustrated as a laptop 122). Mobile device 120 is connected to the internet 215 over a first network connection 235. Also connected to the internet 215 are a software provider website 205 and a partner website 210. System 200 further includes a delivery device host computer 220, which is connected to the internet 215 via a second network connection 225. Host computer 220 includes a memory 230, which stores computer instructions and data for creating a portfolio (hereinafter “portfolio developer software”).

Software provider website 205 provides the portfolio developer software to the user of host computer 220 (typically the seller), and it provides the mobile device software to the user of mobile device 120 (typically the potential buyer). In either case, the seller and the potential buyer may download the appropriate software from software provider website 205, or either may order a CD (or similar medium) from software provider website 205 containing the appropriate software.

Partner website 210 may operate in conjunction with, or may directly operate, software provider website 205. Partner website 210 may be that of a real estate firm or similar organization, which may own delivery device 105, which seller borrows for the sale of a given property. The organization that runs partner website 210 may own a plurality of delivery devices 105. Partner website 210 may maintain links to various sources of information that the portfolio developer software will access in generating a portfolio as described below.

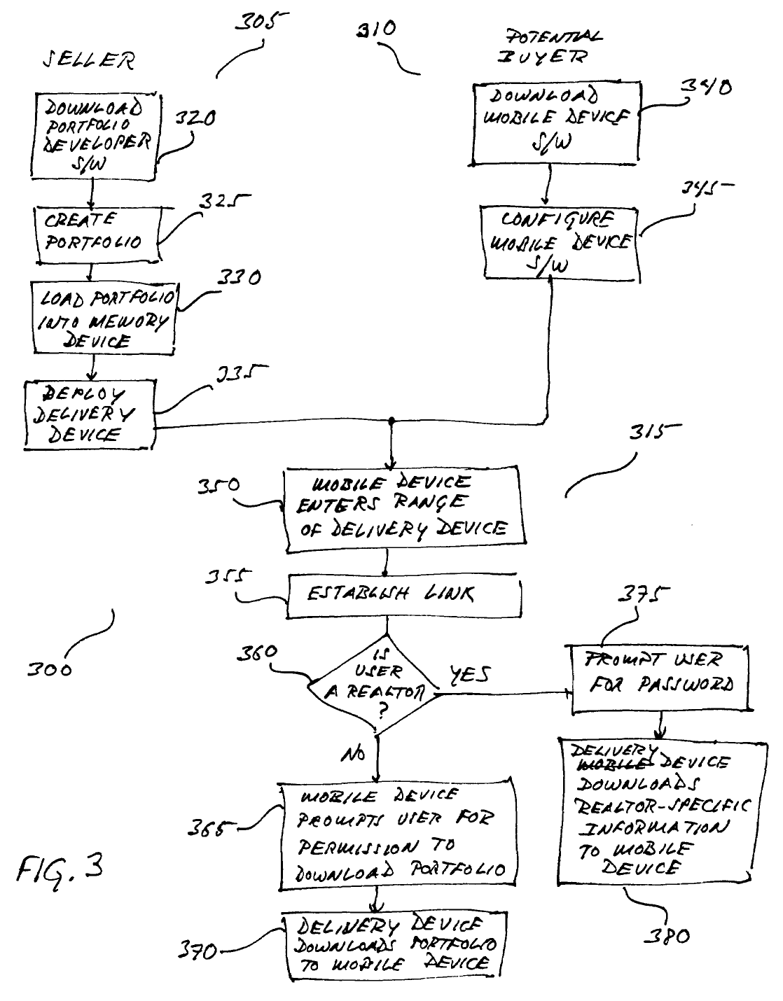

FIG. 3 illustrates an exemplary process 300 for configuring and operating system 200. Process 300 has the following sub-processes: a portfolio development process 305, a mobile device configuration process 310, and a delivery process 315.

In portfolio development process 305, the seller develops a portfolio and loads it into memory device 115 of delivery device 105. In step 320, the seller obtains portfolio developer software from software provider website 205, for example, by downloading the software from software provider website 205. Alternatively, the seller may order a CD (or similar medium) containing the portfolio developer software from software provider website 205.

In step 325, the seller creates a portfolio using the portfolio developer software. In doing so, the seller executes the portfolio developer software on host computer 220. The portfolio developer software prompts the seller for information about the house for sale, such as address, square footage, number of bedrooms and bathrooms, asking price, etc. The portfolio developer software may further prompt the seller for photos and/or videos (in electronic format) of the house. With this information, the portfolio developer software may query various real estate, municipal, and government databases for information pertaining to the house, such as its school district, the schools (elementary, middle, high) corresponding to the house's location, etc. The portfolio developer software may use data templates that are compliant with Multiple Listing Service (MLS) data format standards.

The portfolio developer software may further interact with other services and databases, such as geographic information systems (GIS), to obtain maps of the neighborhood, distance to emergency services, typical seasonal weather, etc. It will be readily apparent to one skilled in the art that many different types of information, which might be of interest to a potential buyer, may be obtained, all of which are within the scope of the invention.

The portfolio developer software may come in different versions, each having a different level of complexity. For example, it may include a basic version, which may be used when minimal information is needed. The portfolio developer software may include an intermediate or a professional version, which will assist in the creation of more elaborate portfolios, containing content such as video tours, or large scale multi-property portfolios that pertain to an entire development. The portfolio developer software may also provide special-purpose versions specifically tailored for, for example, new home sales by builders or high rise apartment building managers.

Further to step 325, after completing the portfolio, the portfolio developer software may transmit the created portfolio to the software provider web site 205 and/or the partner web site 210 to provide supplemental access to the portfolio (e.g., via direct access over the internet) as well as additional links to other related data.

The portfolio developer software may generate multiple portfolios for a given house: one intended for potential buyers, and another intended for realtors. For the realtor-specific portfolio, the portfolio developer software may prompt the seller for a password, which a realtor (using mobile device 120) will be required to provide in order to gain access to the realtor-specific portfolio. Further, the portfolio developer software may generate multiple portfolios intended for potential buyers, each having different levels of complexity, depending on the memory capacity of the potential buyer's mobile device 120. For example, if the potential buyer's mobile device has limited memory capacity (such as a PDA 140), then that potential buyer may opt for a portfolio that does not have a video tour, for example. One skilled in the art will readily appreciate that many such variations to the portfolio developer software are possible and within the scope of the invention.

The seller may want to update or change an existing portfolio. In this case, the portfolio developer software may save existing or previously generated portfolios and allow the seller to make changes. The portfolio developer software may have the capability of extracting one or more portfolios from memory device 115 of delivery device 105 and present it to the seller for updating. The portfolio developer software may provide password protection of an existing portfolio to assure that only the seller, or someone authorized by the seller, may change the information in the portfolio. It will be readily apparent to one of ordinary skill that such features and variations are possible and within the scope of the invention.

In addition to generating one or more portfolios, the portfolio developer software generates instructions (hereinafter “embedded delivery software”) that will be executed by embedded controller 112 within delivery device 105. If WiFi (IEEE 802.11) is the intended wireless communications scheme, the portfolio developer software generates a Service Set Identifier (SSID) that will identify the delivery device 105 to a nearby mobile device 120 that portfolio information is available for download. The portfolio developer software generates an SSID according to a naming convention that will be recognizable to mobile devices 120. Further to a WiFi implementation, the portfolio developer software may generate software components for the embedded delivery software that enable access handshaking to speed up the data rate of wireless link 135 based on the capability of the mobile wireless communication device 125 on mobile device 120.

If a wireless communication scheme other than WiFi is to be used, it will be readily apparent to one skilled in the art how to provide identification information that can alert nearby mobile devices 120 that portfolio information is available for download from delivery device 105. Further, one skilled in the art will recognize that such variations to the wireless scheme, and the embedded delivery software components to enable communications over wireless link 135, are within the scope of the invention.

In step 330, the portfolio developer software loads the portfolio generated in step 325 into memory device 115. If memory device 115 is a removable device, such as a memory stick, the portfolio developer software may load the portfolio into a memory stick inserted into a USB drive on host computer 220. If memory device 115 is integral to delivery device 105, then the portfolio developer software may load the portfolio into memory device 115 by establishing a wireless connection through communication component 110 of delivery device 105 and loading the portfolio via the wireless connection, or by use of a network cable (not shown) connecting host computer 220 to delivery device 105.

In step 335, the seller deploys delivery device 105. In doing so, the seller may place delivery device 105 in the front window of the house, or on the “for sale” sign, etc., depending on the design of delivery device 105. Once placed, the seller activates delivery device 105. The seller may do so by providing electrical power to delivery device 105, by throwing a switch (not shown) on delivery device 105, or by inserting memory device 115 (if a removable memory storage device is used). Other methods for activating delivery device 105 are possible and within the scope of the invention.

In mobile device configuration process 310, the potential buyer obtains and installs mobile device software on his/her mobile device 120. In step 340, the potential buyer obtains the mobile device software from software provider website 205. In doing so, the potential buyer may download the software directly from software provider website 205 via first internet connection 235. Alternatively, the potential buyer may order the mobile device software in the form of a CD (or similar medium) from software provider website 205. In step 345, the potential buyer installs the mobile device software on memory device 130 of mobile device 120.

At the completion of portfolio development process 305 and mobile device configuration process 310, delivery device 105 has been loaded with one or more portfolios, deployed at the house for sale, and delivery device 105 has been activated. Mobile device software has been installed on potential buyer's mobile device 120.

In delivery process 315, the potential buyer, using mobile device 120, enters the vicinity of a house for sale, which has a deployed delivery device 105. Delivery device 105, in response to a query from mobile device 120, transmits all or portions of the portfolio to mobile device 120. This transmission, or delivery, is done preferably on demand.

In step 350, the potential buyer, equipped with mobile device 120 enters within wireless link 135 range of delivery device 105. The mobile device software on mobile device 120 is running and sending instructions to mobile wireless communication device 125 to sense a carrier signal from delivery device 105. If WiFi (IEEE 802.11) is the intended wireless communications scheme, the mobile device software sends instructions to mobile wireless communication device 125 to detect a beacon frame being broadcast by delivery device 105.

Further to step 350, the mobile device software identifies that the sensed carrier signal is associated with a delivery device 105. In the exemplary WiFi implementation, the mobile device software recognizes the Service Set Identifier (SSID) information within the beacon frame and thereby recognizes the presence of a delivery device 105 from which it may download a portfolio.

Further to step 350, the mobile device software may notify the potential buyer of the presence of a delivery device. The mobile device software may then prompt the potential buyer for a command to establish communications over wireless link 135 with the delivery device, or to disregard the presence of delivery device 105.

In step 355, the mobile device software and the embedded delivery software establish communications over wireless link 135. At the conclusion of this step, delivery device 105 and mobile device 120 are communicating, and each are able to send and receive instructions and data.

In step 360, embedded controller 112 within delivery device 105 executes the embedded delivery software to interact with the mobile device software running on mobile device 120. If the embedded delivery software was configured (in step 325) to provide different portfolios based on whether the potential buyer is a realtor, then the embedded delivery software sends (via communication component 110) a query to mobile device 120 asking whether the potential buyer is a realtor. If the potential buyer replies affirmatively, then delivery process 315 proceeds along the “Yes” branch from step 360 to step 375.

In step 375, the embedded delivery software sends another query to mobile device 120, asking for the password created by the seller in step 325 above. If the potential buyer provides the password, which mobile device 120 transmits to delivery device 105 via wireless link 135, then the embedded delivery software compares the received password with that stored in memory device 115. Depending on the result of the comparison, the embedded delivery software executes instructions to transmit the realtor-specific portfolio data from memory device 115 in delivery device 105 to mobile device 120. Further, if delivery device 105 is connected to the internet via a network connection (not shown), then the embedded delivery software may provide internet access to the person who successfully provides a password.

In step 380, the embedded delivery software transmits the realtor-specific portfolio data to mobile device 120 via wireless link 135. The mobile device software running on mobile device 120 then receives the realtor-specific portfolio data and stores it in memory device 130.

Returning to step 360, if the potential buyer is not a realtor, then the potential buyer responds in the negative to the query sent to mobile device 120. Then, embedded delivery software proceeds along the “No” branch from step 360 to step 365.

In step 365, the embedded delivery software sends information to mobile device 120 that it has one or more portfolios that are available for download, along with information about each portfolio, such as the amount of data for each portfolio. In turn, the mobile device software informs the potential buyer of the presence of one or more portfolios. The potential buyer may then select which portfolio is to be downloaded. The mobile device software in turn transmits information pertaining to the selected portfolio to delivery device 105.

In step 370, the embedded delivery software executes instructions to transmit the portfolio data from memory device 115 to mobile device 120 over wireless link 135. Consequently, the mobile device software running on mobile device 120 receives the portfolio data and stores it in memory device 130. The potential buyer may review the portfolio immediately after receiving it from delivery device 105, and then save or delete the portfolio.

At the conclusion of steps 370 and 380, in which a portfolio as been delivered, the embedded delivery software may record information regarding the delivery, such as date, time, which portfolio was delivered, etc., in memory device 115. Further, if information about each delivery is recorded, this information may be deliverable as part of the realtor-specific portfolio that is delivered in steps 375 and 380. This way, a realtor will be made aware of how many potential buyers have inquired about the house for sale.

Many variations to systems 100 and 200, and process 300, are possible and within the scope of the invention. For example, referring to FIG. 2, host computer 220 may be a portable machine, such as a laptop. In this case, the seller may generate a new portfolio, bring host computer 220 to delivery device 105 that is deployed at the house, and then wirelessly load the new portfolio into memory device 115. This may be useful if information in the portfolio changes, such as the asking price of the house.

It is possible to have one delivery device 105 for a new housing development in which the potential buyer may peruse a list of portfolios and download only those of interest. For example, a delivery device 105 may have multiple portfolios stored in memory device 115: one pertaining to the development as a whole, and a plurality of portfolios, one for each house within the development. The portfolio for the development as a whole may show amenities, recreational facilities, etc. Here, a potential buyer may choose to download only portfolios pertaining to particular houses, such as townhouses, or houses within a certain price range, in addition to the portfolio for the development as a whole.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

What is claimed is:

1. A system for transmitting, on demand, a portfolio of information pertaining to real property, comprising:
a portfolio delivery device having a first wireless communication component, an embedded controller, and a first computer readable medium, wherein the first computer readable medium is encoded with data corresponding to the portfolio and a first program, wherein the first program transmits all or part of the portfolio on demand; and
a mobile device having a second wireless communication component, a processor, and a second computer readable medium encoded with a second program, wherein the second program identifies a wireless transmission from the portfolio delivery device, establishes a wireless link with the portfolio delivery device, requests the portfolio from the portfolio delivery device, and receives data corresponding to the portfolio from the portfolio delivery device.

2. The system of claim 1, wherein the portfolio delivery device further includes a battery power source.

3. The system of claim 1, wherein the portfolio device further includes a solar cell.

4. The system of claim 1, further comprising a host computer having a third computer readable medium encoded with a program for creating the portfolio and for loading the portfolio into the first computer readable medium.

5. The system of claim 4, further comprising a software provider computer connected to the host computer over a network, wherein the software provider computer has a fourth computer readable medium encoded with a software provider website, wherein the software provider website provides a downloadable version of the program for creating the portfolio and a downloadable version of second program.

6. The system of claim 1, wherein the portfolio of information pertaining to real property comprises photos of the real property.

7. A computer readable medium encoded with a program for creating a portfolio for promotional information on real property products, the program comprising:
a software component for requesting and receiving product information from a seller;
a software component for querying one or more databases for additional product information based on the product information received from the seller;
a software component for assembling portfolio based on the product information and the additional product information, according to a template; and
a software component for generating a program for transmitting the portfolio in response to a request.

8. The computer readable medium of claim 7, wherein the program for transmitting the portfolio further includes a program for recording information corresponding to the transmitting of the portfolio.

9. The computer readable medium of claim 8, wherein the program further comprises a software component for storing information received from a mobile device.

10. The computer readable medium of claim 7, further encoded with a software component for loading the portfolio and the program for transmitting the portfolio into a memory device.

11. The computer readable medium of claim 7, wherein the product is a house.

12. The computer readable medium of claim 11, wherein the software component for requesting and receiving product information includes a program for requesting and receiving an address of the house.

13. The computer readable medium of claim 11, wherein the software component for querying one or more databases for additional product information includes a program for querying a first database for information pertaining to a school district.

14. A method for transmitting a portfolio on demand, comprising:
obtaining a program that generates the portfolio;
executing the program;
providing information pertaining to a real property in response to a prompt from the program;
commanding the program to generate the portfolio and to generate an embedded program that transmits the portfolio to a mobile device over a wireless connection in response to a request from the mobile device;
commanding the program to load the program into a memory device, wherein the memory device is connectable to a delivery device; and
placing the delivery device, which is connected to the memory device, in or near the product.

15. The method of claim 14, further comprising retrieving from the memory device information corresponding to a number of times the embedded program transmitted the portfolio.

16. The method of claim 14, wherein obtaining the program comprises downloading the program from a website.

17. The method of claim 14, wherein providing information pertaining to a real property comprises entering an address of a house for sale.

18. The method of claim 17, wherein commanding the program to generate the portfolio comprises commanding the program to query a database for information corresponding to the address.

19. The method of claim 18, wherein commanding the program to generate the portfolio comprises commanding the program to query the database for school district information.

20. The method of claim 14, wherein providing information comprises providing a password.

21. A device for transmitting a portfolio of information pertaining to a real property, comprising:
a wireless communication component;
an embedded controller connected to the wireless component; and
a computer readable medium connected to the embedded controller, wherein the computer readable medium is encoded with data corresponding to the portfolio of information pertaining to a real property and a program that transmits all or part of the portfolio when requested by a mobile device, and wherein the portfolio delivery device is not connected to the internet.
